(19) United States
(12) Patent Application Publication
(10) Pub. No.: US 2002/0136386 A1
(43) Pub. Date: Sep. 26, 2002

(54) Method and system for operating a team configuration formed of a number of subscribers

(76) Inventor: Harald Berger, Paderborn (DE)

Correspondence Address: BELL, BOYD & LLOYD, LLC, P. O. BOX 1135, CHICAGO, IL, 60690-1135, US

(21) Appl. No.: 10/015,017

(22) Filed: Dec. 10, 2001

(30) Foreign Application Priority Data
Dec. 8, 2000 (DE) 100 61 295.4

(51) Int. Cl. H04M 7/00

(52) U.S. Cl. 379/219; 379/221.03

(57) ABSTRACT

Method and system for operating a team configuration in an arrangement formed of a number of telecommunications devices, with the telecommunications devices communicating with one another with equal priority, wherein a real or an imaginary instance exists, in addition to the process instances provided for normal telecommunications operation, for each subscriber in each telecommunications device.

### BACKGROUND OF THE INVENTION

Methods and arrangements such as these are known, for example, from International Laid-Open Specification WO 98/15134 and German Laid-Open Specification DE 197 52 403 A1. These are based on the approach of the team functionality being controlled centrally within a telecommunications system or a telecommunications server. In this case, either the entire control or at least central parts of the control of the team functionality is or are carried out within a telecommunications system. Team subscribers who are connected to another telecommunications system are, for example, controlled via what are referred to as extension connections from the first-mentioned, controlling telecommunications system; frequently also referred to in the literature as the central “master system”.

One corresponding configuration is illustrated schematically in FIG. 1. The inscription in this FIG. 1 is self-explanatory, therefore requiring no further explanation.

These known solutions basically have the following disadvantages:

Failure of the team functionality in all the remote telecommunications systems in the event of failure of the master system, or in the event of a failure in the connection to the master system.

In the event of failure of the master system, it is no longer possible to access the remote team subscribers, although they can themselves make telephone calls.

Since the team functionality is controlled from a central master system, increased performance requirements are placed on the master system.

Since each individual team subscriber is controlled from a master system, this results in an increased amount of signaling traffic, since each team subscriber must be controlled individually on a remote system; for example, connect the signaling for a team call via an LED.

The two items mentioned above result in such a solution approach having poor scalability. That is, large distributed teams are difficult to implement since the signaling complexity between the remote telecommunications systems and the master system increases linearly with the number of remote team subscribers.

The present invention is, therefore, directed toward specifying an improved method of this generic type and a corresponding system which, in particular, have better noise immunity, have less associated signaling traffic, and are more easily scalable.

### SUMMARY OF THE INVENTION

The present invention includes the fundamental idea of configuring all the telecommunications systems in the team configuration to be equivalent to one another; that is to say none of the telecommunications systems is assigned a central role for controlling the team functionality. It also includes the idea of using an imaginary instance (also referred to as a “shadow instance” or “imaginary team subscriber”=ITS) for each team subscriber which, although configured, has no physical corresponding instance in a telecommunications system, and of using this for controlling the team functionality. In contrast, there is a real instance (also referred to as a “real team subscriber”=RTS) in that telecommunications system to which the corresponding subscriber is physically connected (his/her “home telecommunications system”). The imaginary and real instances of the team subscribers, that is to say the team data, exist alongside the actual process instances which are required for conventional telephony operation.

FIG. 2 shows the concept of an “imaginary team subscriber”. A subscriber whose telephone number is 4712 is physically connected to the telecommunications system 2 (home) and is, thus, a real team subscriber in the team control for this telecommunications system, while existing as an imaginary team subscriber in the team controls for the telecommunications systems 1 and 3.

The decentralized approach of the present invention results in the overall solution being less susceptible to failures. That is, the failure of one telecommunications system or of the connection between two telecommunications systems does not lead to loss of the team functionality in the remaining telecommunications systems in the network, but only to failure of the team functionality with regard to the team subscribers in the failed segment of the network.

Owing to its good scalability, the present invention allows the implementation of teams with a large number of subscribers in one team, and a large total number of team subscribers overall.

The present invention makes it possible to minimize the signaling between the telecommunications systems and, thus, requires less transmission bandwidth between the telecommunications systems than other solutions. The solution also allows costs to be saved in situations in which the telecommunications systems are physically separated and require rented lines to one another for connection of the individual telecommunications systems.

Furthermore, the signaling between the telecommunications systems required for the present invention is independent of the connection that is used between the telecommunications systems, and it can be provided via different, and even unprotected, connections and protocols.

The solution described in the present invention automatically identifies the loss of signaling-related message elements or the failure of a partner system and, on identifying such a fault situation, automatically resets all the subscriber signaling activities.

The present invention is likewise characterized in that inconsistencies in the team configurations of the various telecommunications systems within the telecommunications network are also identified automatically, thus making it possible to avoid severe fault situations.

The present invention also affords additional complexity to be low in comparison to a team solution based on an individual telecommunications system.

In accordance with what has been stated above, particularly in the case of a team configuration formed of n telecommunications systems, each subscriber is assigned an individual real instance and n-1 imaginary instances or shadow instances.

A real instance also always has various associated process instances, since these are required for telephony operation. In contrast, an imaginary instance does not have such processes, since the imaginary instances themselves do not control any communications terminal, but are used only for further distribution of the calls of a real instance. In this sense, the relationship between a real instance and the imaginary instances associated with it also can be described as a master-slave relationship.

One major advantage of the approach selected by the present invention is that the real instances and the imaginary instances are identical, except for the lack of the associated process instances for the imaginary instances.

The signaling between the telecommunications systems takes place via individual message elements, which are also referred to as “datagrams” in the following text.

Relevant terms and abbreviations are explained in the following text in conjunction with the explanation of the present invention:

Team

a group of subscribers:

who belong to the same call number plan;

who may be located in different networked telecommunications systems;

whose calls are signaled within the group as a function of the configuration; and

to which a team number is allocated.

A number of teams may be used in one telecommunications system or in a network of telecommunications systems.

TS—Team Subscriber

Subscribers in a team, having the following features:

the incoming calls for this TS can be signaled to other subscribers in the same team;

the incoming calls for other subscribers in the same team can be signaled to this TS;

the TS can accept the calls for other TSs;

the calls for this TS can be accepted by other TSs;

one TS can allocate a call to another TS;

one TS can select or deselect the call distribution for his/her calls; and

one TS can select or deselect call acceptance for the calls signaled to him/her by his/her team partners.

RTS—Real Team Subscriber

In the telecommunications system relating to this subscriber, this subscriber has a logical address, which is followed by a telephone number, and has the following features:

an RTS is possible both on individual systems and in network telecommunications systems;

in the case of an RTS in a group of systems, the expression home of the TS is also used;

an RTS can protect subscriber-specific data and, thus, for example, store the key position at which another team partner is monitored; and

one RTS typically has one physical corresponding instance (that is to say, a connected communications terminal); however an RTS may also be a “virtual team subscriber”.

ITS—Imaginary Team Subscriber

These subscribers are not located in the system relating to this subscriber. That is, the subscriber has no physical or virtual corresponding instance in this system and, of course, also no logical address, but has the following further features:

the telephone number of this subscriber is located in the same selection tree as that of his/her team partners, and cross-refers to the start-up of another system;

an ITS always includes an RTS;

in the case of n-networked telecommunications systems, one RTS has (n-1) associated ITSs;

an ITS has no instance data for a telecommunications terminal, but only team data;

an ITS cannot protect subscriber-specific data;

the data for an ITS are reconstructed, inter alia, from the team data for the RTSs in the system; and

an ITS distributes the calls of the associated RTS to a partner system.

VTS—Virtual Team Subscriber

A virtual team subscriber is a team subscriber without a physical corresponding instance. That is, the virtual team subscriber is a subscriber with his own logical address, his/her own instance data and his/her own telephone number, which can distribute team calls, but having no associated physical instance, and having the following features:

the VTS cannot itself accept calls or occupy a line;

the VTS is, for example, used for call distribution in the team; and

a VTS is a help construct in a team configuration, which is used, independently of the networking problem, to increase the number of externally accessible telephone numbers in the team, without having to increase the number of actual subscribers (for example, a subscriber may be accessible at three different telephone numbers).

TP—Team Partner

All TS within a team, except for the TS itself.

TK—Team Key

Key of a TS which is monitoring a TSP:

TKs are either predetermined in a fixed manner by the configurator or can be freely programmed in accordance with requirements defined by the configurator; and

TKs are described by a virtual key position for the telephone number of the team partner, the signaling type and the associated call rhythm.

VTK—Virtual Team Key

Option of a TS to be able to store a TP for a freely programmable function key.

Home

The expression home of a team subscriber is used in network telecommunications systems with regard to the RTS (see above).

Virtual Key Position

Unique map of a physical key position (key number+indication of the terminal or telephone number transmitter) onto an associated numerical area.

Logical Address

The logical address is a unique index for addressing a subscriber within a telecommunications system (a telephone number represents a unique index only in the case of a common telephone number plan and, in principle, connected subscriber groups are also used, and it is possible to use a telephone number more than once within different, closed subscriber groups).

A logical address is a unique index only within one telecommunications system, and does not cover a number of systems.

Instance

Various processes (for example, LTG, END, TAK) and the associated data areas are required for operation for each subscriber.

These are also referred to as an instance or incarnation of this subscriber.

Instance Data for a Subscriber

Each subscriber has his/her own instance data, which includes his/her current statuses, configuration and subscriber-specific data. Such data is partially also protected, and then also is still available after a failure of the telecommunications system.

Team Data

This is data which is required for the team functionality, having the following features:

the team data is linked to the telephone number and the team number of a team subscriber;

access to one's own team data and to the team data for the team partners is possible via the instance data for an RTS, using the team subscriber index (M);

a central process (UTI) can access team data of all the other team subscribers; and

ITSs have only team data (there is no instance and no instance data (END, LTG and TAK process) for an ITS).

tsi—Team Subscriber Index

A unique index, which identifies a team subscriber, within the team control in a telecommunications system.

CO—Central Operation

That part of a telecommunications system which is responsible, inter alia, for the configuration of the telecommunications system.

CS—Central Switching

That part of a telecommunications system which is responsible for setting up and handling “classical switching functions”.

DHSYM—Device Handler SYMphony

That part of the telecommunications system which is responsible for controlling system terminals.

The team control on which the present invention is based is implemented in this DHSYM.

END, LTG and TAK Process

Various processes for controlling a terminal within the DHSYM, and for each of which each subscriber has one.

UTI Process

Central process within the DHSYM, of which there is only one for all the terminals.

Additional features and advantages of the present invention are described in, and will apparent from, the following Detailed Description of the Invention and the Figures.

### BRIEF DESCRIPTION OF THE FIGURES

FIG. 1 shows a general schematic illustration of a known approach to team functionality being controlled centrally within a telecommunications system.

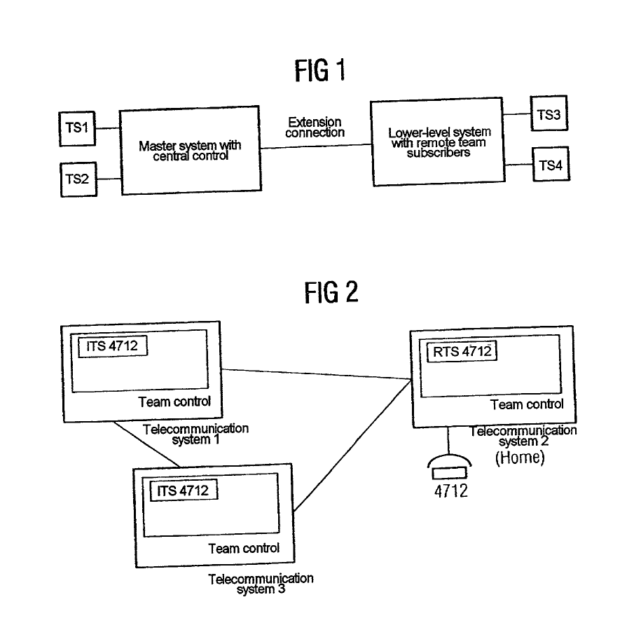

FIG. 2 shows a schematic illustration of the concept of an “imaginary team subscriber.”

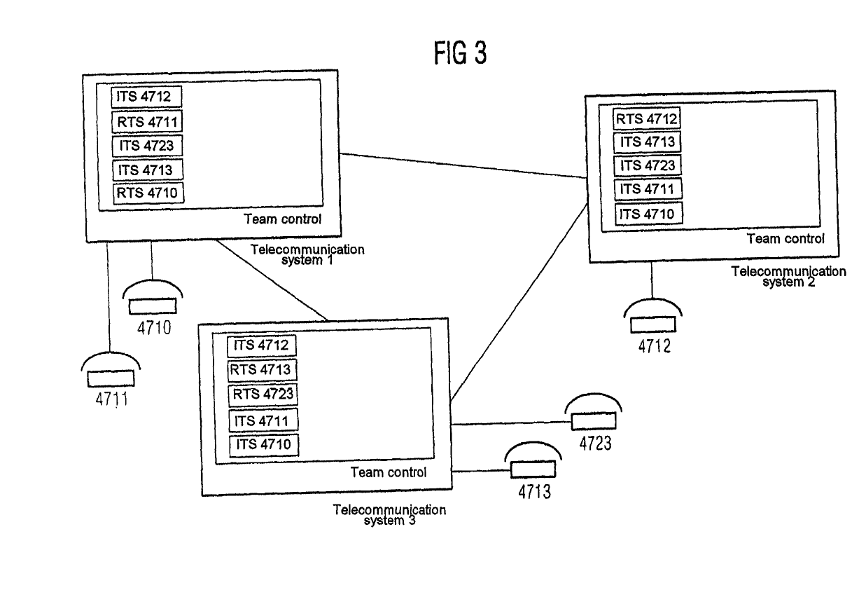

FIG. 3 shows a schematic illustration of a distributed team configuration formed of five subscribers.

FIG. 4 shows an illustration of the distribution of an incoming call within the distributed team shown in FIG. 3.

FIG. 5 shows an example of an illustration to explain fault identification and handling in a team configuration shown in FIG. 3.

FIG. 6 shows a schematic illustration of the layout of telecommunications systems, from which a system according to an exemplary embodiment of the present invention is formed.

FIG. 7 shows a schematic illustration of the distribution of a team call in a single system according to one embodiment of the present invention.

FIG. 8 shows a schematic illustration of the routing of a call between networks, according to one embodiment of the present invention.

FIG. 9 shows an illustration of a communication diagram between systems, for one embodiment of the present invention.

FIG. 10 shows a schematic illustration to explain the memory organization in conjunction with the implementation of a team call in one embodiment of the present invention.

### DETAILED DESCRIPTION OF THE INVENTION

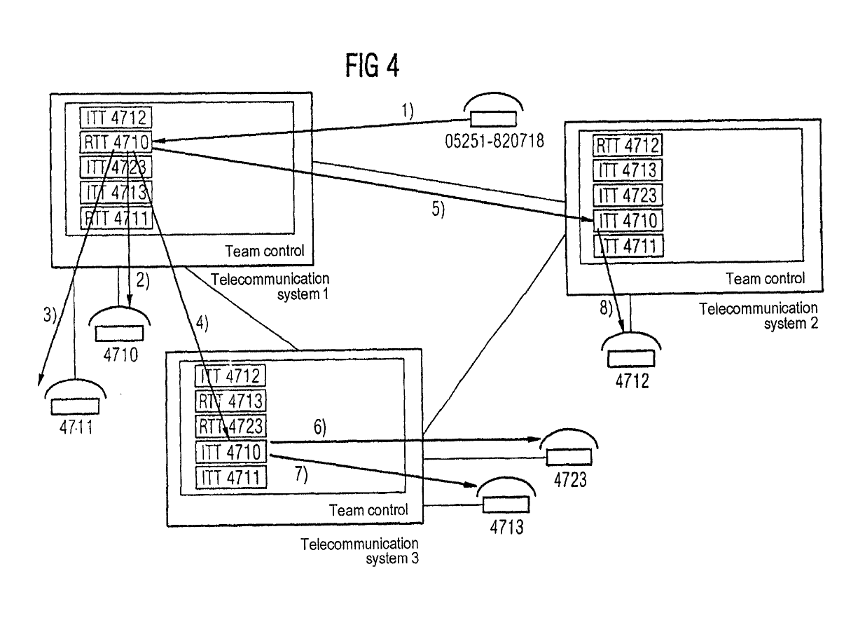

FIG. 3 shows a distributed team configuration formed of five subscribers. Two team subscribers are, in each case, physically connected to both the telecommunications system 1 and the telecommunications system 3. One team subscriber is physically connected to the telecommunications system 2. The individual telecommunications systems accordingly have different RTS and ITS instances (see Table 1).

| | Telecommu- | Telecommu- | Telecommu- |
|---|---|---|---|
| Telephone | nications | nications | nications |
| number | system 1 | system 2 | system 3 |
| 4710 | RTS | ITS | ITS |
| 4711 | RTS | ITS | ITS |
| 4712 | ITS | RTS | ITS |
| 4713 | ITS | ITS | RTS |
| 4723 | ITS | ITS | RTS |

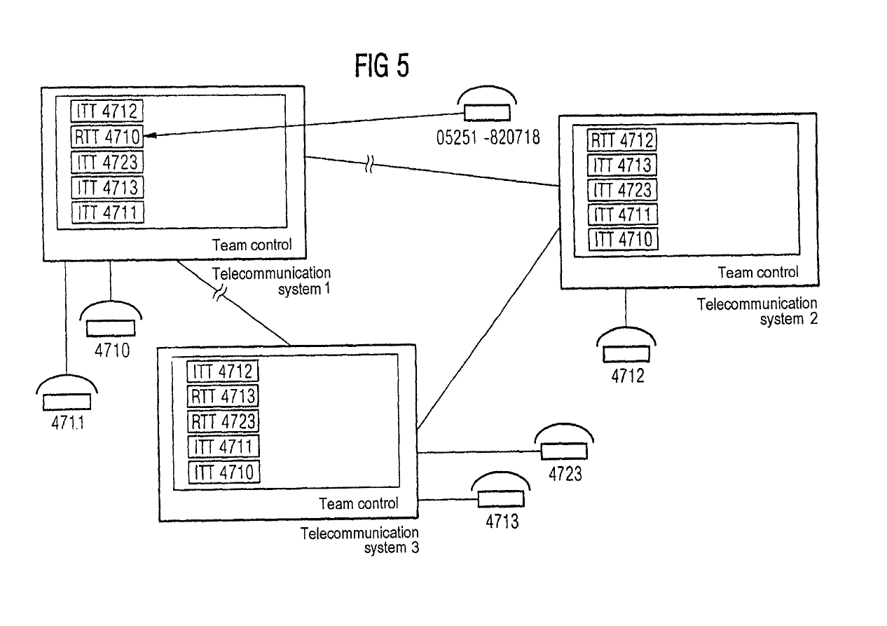

FIG. 4 shows, schematically, a situation in which an incoming call within the team is distributed between the telecommunications systems 1, 2 and 3.

In a first step 1), the incoming call is passed to the RTS instance of the subscriber 4710 in the telecommunications system 1.

In a second step 2), the incoming call is passed to the subscriber 4710; that is, the bell rings on the communications terminal whose telephone number is 4710.

In a third step 3), the call is distributed to the team partner 4711 within the telecommunications system 1.

In a fourth step 4), the RTS instance of the subscriber 4710 determines that this subscriber has activated call distribution and is also being monitored by team partners in the telecommunications system 3. The RTS instance of the subscriber 4710 then sends a message, with the parameters of the call, to the telecommunications system 3, irrespective of how many subscribers in the telecommunications system 3 are monitoring the subscriber 4710, and independent of whether these subscribers have or have not activated call transfer for team calls.

If the subscriber 4710 has not activated call distribution, then, although the parameters of the call are buffer-stored, the telecommunications systems 2 and 3 are not informed of this call. The telecommunications systems 2 and 3 are informed only if the subscriber 4710 has activated call distribution and in cases in which the call is still waiting. The parameters of the incoming call are stored in the ITS instance of the subscriber 4710 and, possibly, are distributed to the team subscribers [see the following steps 5) and 6)].

If there is no ITS instance for the subscriber 4710 in the telecommunications system 2, as will be the situation, for example, in the event of an inconsistent database in the networked telecommunications systems, then this fault situation can now be identified and an appropriate fault reaction can be initiated.

In a fifth step 5), the RTS instance of the subscriber 4710 finds that the subscriber 4710 is also being monitored by team partners in the telecommunications system 2, and sends a message to the telecommunications system 2 [analogously to step 3)].

The ITS instance of the subscriber 4710 has been signaled in the incoming call. In a sixth step 6), this call is now distributed to the corresponding team partners. On the basis of the data for the ITS instance of the subscriber 4710 in the telecommunications systems 3, it is confirmed that this is being monitored by the subscriber 4723, and the RTS instance of the subscriber 4723 is used to determine that the subscriber 4723 has activated call acceptance. The incoming call is now signaled to the team subscriber 4723 as if it were the team call for a team partner in its own telecommunications system 3.

In a seventh step, analogous to step 6), the team call is signaled to the subscriber 4713.

In an eighth step, analogous to step 6), the team call is signaled to the subscriber 4712 in the telecommunications system 2.

The networked signaling of other switching statuses, such as

team subscriber is busy,

team subscriber is free,

end of the call for the call subscriber,

is carried out analogously to the distribution of a call as described above.

If a call for a team partner, for example 4710, in another telecommunications system is signaled to a team subscriber, for example the subscriber 4713, then the team subscriber can accept this call for his/her team partner. This is done by deliberate call checking; that is, the subscriber 4713 signals the telecommunications system 1 that he/she wishes to accept the call for the subscriber 4710, and the telecommunications system 1 transfers this call to the subscriber 4713 in the telecommunications system 3.

The present invention uses various mechanisms for fault identification in order to ensure stable operation of a networked team, for example:

the identification of the failure of a partner telecommunications system, or of the failure of the routing paths to this telecommunications system;

the identification that a partner telecommunications system has been newly started up;

the identification of losses of one or more messages in the communication with a partner system; and

the identification of inconsistent team configurations.

If the team control identifies that communication with a partner system is subject to interference, then all signaling activities of switching statuses which relate to this telecommunication system are reset; that is to say, an existing team call is automatically ended by an “end call”, irrespective of whether the partner is still being called, or not. In the time period which is required to reset the cross-connections to the failed partner system, no new stimuli are accepted from the failed partner system. Once all the call statuses have been reset, the team functionality is no longer available for that failed telecommunications system.

If the telecommunications system now once again receives a stimulus from the partner system that has previously failed, the signaling of call statuses starts again; that is, functionality between the systems is again available. For performance reasons, the switching statuses of the team subscribers are not all refreshed on an “initial contact” or on “reconnection” of the networked telecommunications systems.

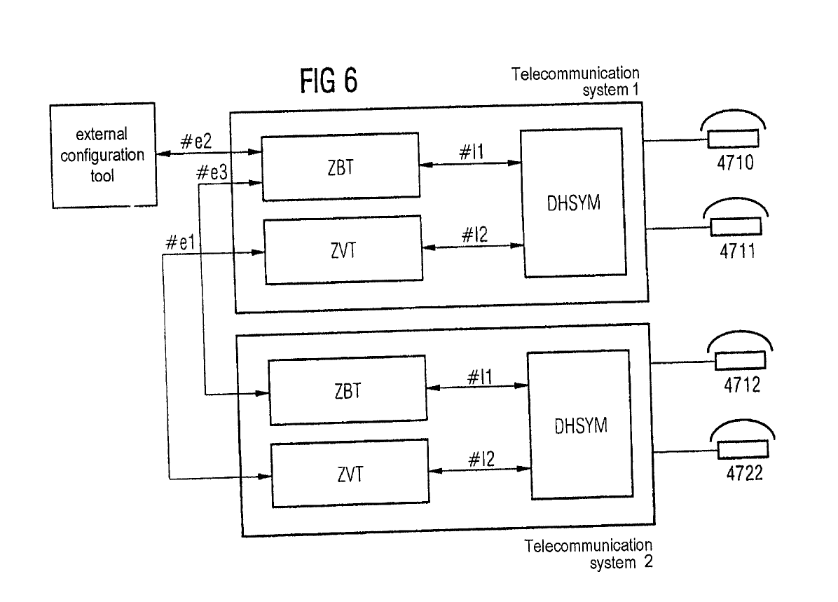

In FIG. 5, it is assumed that the connections between the telecommunications system 1 and the telecommunications systems 2 and 3 have been disconnected. The exchange line for the telecommunications system 1 has, however, been maintained, and the subscriber 4710 is still being called. The call is also signaled to the team partner 4711 in the telecommunications system 1, and the call can also be received there.

The team controls for the telecommunications systems 2 and 3 identify (for example, after a specific time period or when trying to accept the call for the team partner 4710) that the connection to the telecommunications system 1 has been interrupted. The signaling of the call for the team subscriber 4710 is now automatically reset by the team controls in the telecommunications systems 2 and 3 and not, as in “normal” operation, by the telecommunications system 1. The team functionality of the telecommunications systems 2 and 3 is now reduced by the subscribers in system 1, in the same way as only local team functionality, in the system 1.

The functionality between networks for telecommunications systems 2 and 3 is, however, still fully maintained. That is, if the subscriber 4723 in the telecommunications system 3 now receives a call, then this call is also signaled to the team subscriber 4712 in the telecommunications system 2. This indicates the greater robustness of the described solution in comparison to a solution which is not completely decentralized, such as that described in International Laid-Open Specification WO 98/15135.

The configuration of the teams between networks is carried out via a program, which runs on one of the telecommunications systems or is started in an external computer. This program runs independently of the actual team control, and is not required for actual operation of the team, but only for configuration between networks.

The team configuration is responsible for the consistency of the data for the distributed teams, and allows new team subscribers to be included in a team, subscribers to be deleted from a team, or amendments to the presets as to which team subscribers may monitor which team partners. To do this, this program demands the current team configuration from the individual telecommunications systems, and then carries out processing using the “real team subscribers” (RTS) data.

The team functionality offered on a system-wide basis corresponds to the team functionality of an individual system described in German Laid-Open Specification DE 917 52 403 A1. The following team performance features are implemented.

1) Signaling of team calls (configuration-dependent):

audible (normal call or short call);

in the display of the corresponding terminal; and

on the LED of the corresponding team key on the terminal (blinking).

2) Signaling of busy states via a LEDs on the corresponding team key on the terminal.

3) The capability to receive a team call:

via the team key on the terminal; and

via an appropriate menu item in the display, even if there is physically no corresponding team key whatsoever, for example on a DECT mobile telephone.

4) The capability to call a team subscriber directly via the associated team key.

5) The capability to allocate a call to a team subscriber via the associated team key.

6) The capability to activate or deactivate the distribution of one's own calls in the team:

via a separate function key; and

via a menu item.

7) The capability to activate or deactivate the signaling of other team calls on one's own terminal:

via a separate function key; and

via a menu item.

8) The capability to freely program the nature of the signaling of a team call via a team key (key position, signaling type, that is to say the type of call [short, normal, silent, . . . ], display signaling [yes/no] . . . ).

9) The use of virtual team subscribers, that is to say of team subscribers who have no physical instance, but do have their own telephone number, whose calls are distributed in the team.

The layout of a telecommunications system, such as that used in the present invention, and the various associated modules, tasks and processes already have been described in detail above, and will be outlined only briefly in the following text.

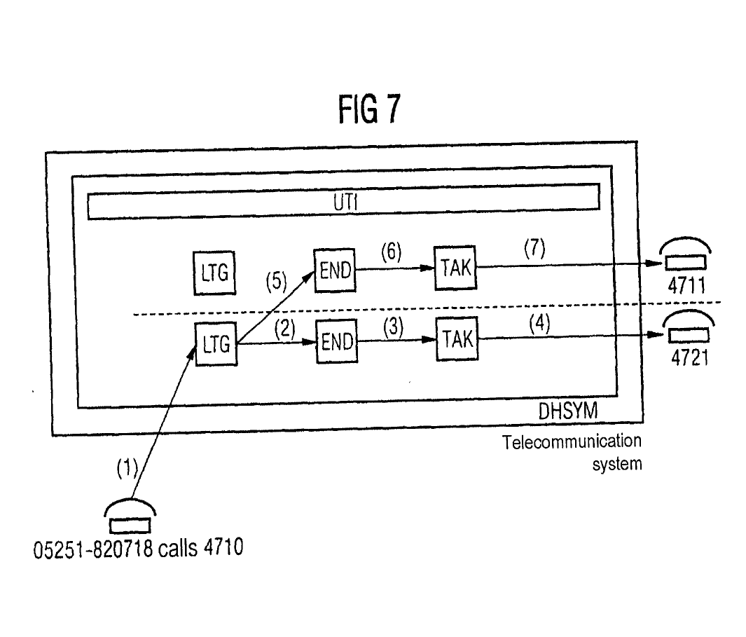

FIG. 6 shows two network telecommunications systems in simplified form. The team control is, in this case, allocated to the DHSYM complex. The terminals with team functionality are controlled by the DHSYM. The DHSYM communicates with the components CO and CS via the internal interfaces #11 and #12.

The communication which is required for configuration of the team data takes place via the interface #11. The communication which is required for call signaling between systems within networked teams takes place via the interface #12.

The DHSYM uses the CS component of its own TK system to address the external interface #e1 and, furthermore, the CS component of the partner system, which passes the signaling on to the DHSYM in the partner system. The external interfaces #e2 and #e3 are used by the CO component for, inter alia, configuration of teams between systems.

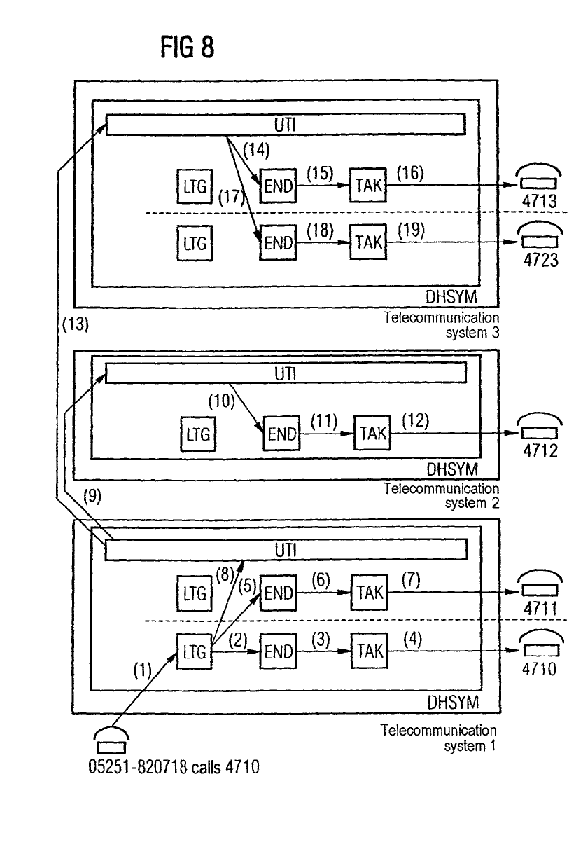

FIG. 7 shows the distribution of a call within a single system. The subscriber 4710 receives a call: (1). This call is signaled to its own terminal: (2) to (4). The team data is used in the LTG components of the subscribers 4710 to establish that the subscriber 4711 is actively monitoring the subscriber 4710, and the call is also signaled to the subscriber 4711: (5) to (7).

The terminal control via the three processes LTG, END and TAK illustrated here is only one example of a specific implementation of the present invention. In principle, the team control on which the present invention is based can also interact with differently structured terminal control (for example, only one process per terminal).

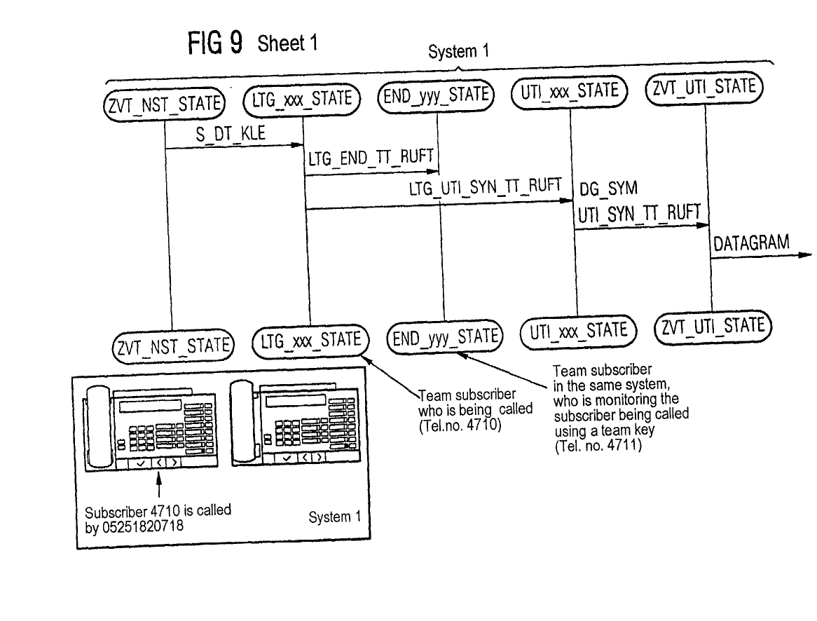

FIG. 8 shows the routing of a team call between networks. As in FIG. 7, the subscriber 4710 is being called.

The sequences for the routing [(1) to (7)] within the telecommunications system 1 are identical to those for a single system. The LTG process for the subscriber 4710 being called now accesses the team data to establish that this subscriber 4710 is also being monitored by team partners in other telecommunications systems, and the LTG process sends a message to the global UTI process (8).

This UTI process has access to the team data of all the subscribers (ITS and RTS). The UTI process now uses the team data to determine the telecommunications systems in the network in which the subscriber number 4710 will still be monitored, and thus compiles a list of the relevant telecommunications systems. A message [(9) and (13)] is now sent to each relevant telecommunications system, that is to say to each telecommunications system in the network in which at least one team subscriber is monitoring the subscriber 4710, containing the following information:

the subscriber 4710 is being called;

the subscriber 4710 is in team No. 2; and

the call parameters, for example:

if known, the telephone number and the name of the caller;

the call rhythm; and

the subscriber type of the caller, etc.

Once the messages (9) and (13) have been received in the telecommunications systems 2 and 3, the team data for systems 2 and 3 are investigated to determine whether there is an “imaginary team subscriber” with the telephone number 4710, who is in team No. 2.

If this is not the case, then this is an inconsistent team configuration, and fault action can now be introduced; for example, a fault message can be issued.

However, if an ITS instance is found for the telephone number 4710 in team No. 2, then the data for the call (telephone number of the caller, . . . ) is initially buffer-stored in the data for that ITS instance. After this, the data for the ITS is used to determine which actual team subscribers in the corresponding telecommunications systems 2 and 3 are monitoring the subscriber 4710. A determination is now made for each of these team subscribers as to whether the subscriber has activated call acceptance in the team.

The UTI process now generates a message to the END process of the RTS [(10, (14) and (17)] for all the relevant RTSs. In this message, as the sender of the LTG process, the subscriber 4710 is simulated, that is to say the signaling of the team call behaves analogously to that in an individual system for the END process and the subsequent sequences [(11), (12), (15), (16), (18) and (19)].

However, if an RTS, for example 4723 in the telecommunications system 3, which did not activate call transfer, now had a call still waiting even though the subscriber had activated call transfer, then the call can also be passed on with the delay on the basis of the call data buffer-stored in the ITS data. However, if the subscriber 4710 has switched off call distribution, and this subscriber is called, then the data for the call is buffer-stored in the team data for that subscriber (RTS), but is not distributed. If the subscriber 4710 now selects call distribution, and the call is still present, then the call is distributed on the basis of the data buffer-stored in the team data.

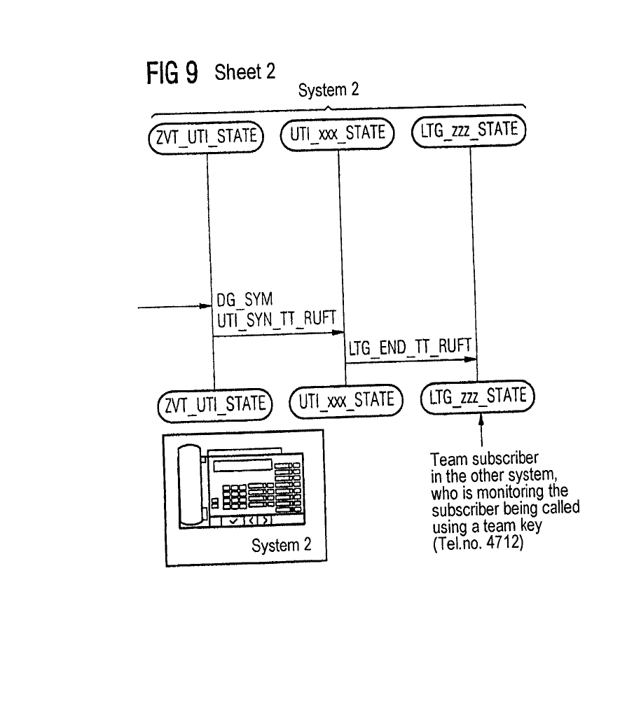

FIG. 9 shows the routes for a team call between systems, in the form of a communication diagram.

The component CS sends the message S_DT_KLE to the LTG process for the subscriber 4710, thus signaling to this subscriber 4710 that he/she is being called. The LTG process for the subscriber 4710 uses the message LTG_END_TS_RUFT to signal the team call to the END process for the subscriber 4711. The routing between systems is initiated by the message LTG_UTI_SYN_TS_RUFT. The UTI process now sends the message DG_SYM/UTI_SYN_TS_RUFT to the CS component, which then routes the datagram to the telecommunications system 2.

In the telecommunications system 2, the CS component now sends the message DG_SYM/UTI_SYN_TS_RUFT on to the UTI process. The UTI process then determines the relevant instances of the team partners, and sends the message LTG_END_TS_RUFT to the subscriber 4712.

The structure of the team data has already been described earlier.

The team data for a subscriber has had additional parameters added to it for routing between systems; for example, this includes the system number of a TS.

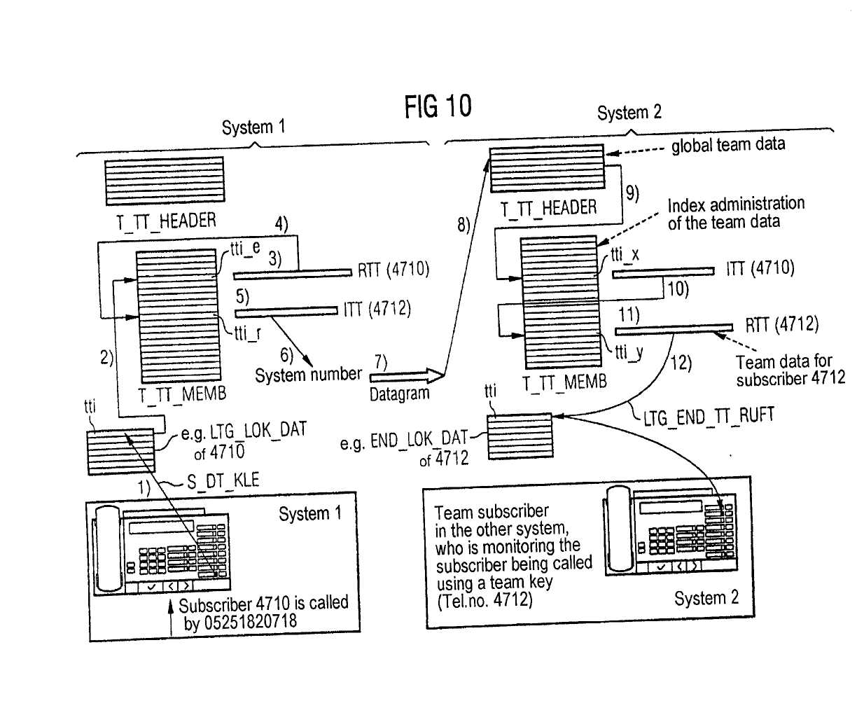

FIG. 10 shows a schematic illustration to explain the memory organization in conjunction with the implementation of team call.

The access to the data is described using the example of signaling of a team call between systems. A team subscriber (telephone number 4710) in system 1 is called by the exchange (telephone number 05251820718). A further team subscriber (telephone number 4712) in the same team, but in another system (system 2), monitors the subscriber being called, using a team key. The incoming call of the team partner is signaled to the subscriber (4712) on the LED of this team key, via a short call and in the display.

1) The LTG process for the subscriber 4710 is passed the message S_DT_KLE.

2) The local data for the LTD process (LTG_LOK_DAT) for the subscriber is used to determine the team subscriber index (gp->tsi) for that subscriber 4710.

3) The tsi can be used to access the dynamic data for the team subscriber 4710 (this is an RTS, that is to say the TS has instance data in this system).

4) The dynamic team data for the subscriber 4710 is used to determine the team subscriber indices for those subscribers to which the incoming call is intended to be distributed; in this case, the tsi of the subscriber 4712.

5) The tsi, found in this way, for the subscriber 4712 makes it possible to access the dynamic team data for the subscriber 4712; in telecommunications system 1, the subscriber 4712 is an ITS, that is to say there is no instance data for this subscriber in the telecommunications system 1.

6) The system number at which this subscriber has his/her home, that is to say at which the subscriber is the RTS, is taken from the dynamic team data for the subscriber 4712.

7) The telecommunications system 2 is informed of the incoming message via a datagram.

8) The datagram contains the information that the incoming call is intended to be distributed to the subscriber 4710; the tsi is determined for the telephone number 4710 in the telecommunications system 2 from the global administration data for the team.

9) The tsi for the subscriber 4710 is used to access the dynamic team data for the subscriber 4710 in the system 2; the subscriber 4710 in the telecommunications system 2 is an ITS.

10) The dynamic team data for the subscriber 4710 in the telecommunications system 2 is used to determine the tsi of that subscriber to which the call is intended to be passed in this telecommunications system 2 (must be an RTS in this system).

11) This tsi is used to access the dynamic data for the subscriber 4712.

12) If the subscriber 4712 has activated call acceptance and is using a real team key to monitor the team partner 4710, then the END process instance of the subscriber 4712 is determined, and the message LTG_END_TS_RUFT is sent to the END process.

13) The END process then controls the signaling of the team call, that is to say the call type, the display signaling and the LED control.

The team subscriber indices (tfi) of the various telecommunications systems can assume different values for one and the same subscriber in the different telecommunications systems, that is to say the applicability area of a tsi is restricted to one system.

The identification of inconsistent team configurations has already been described further above.

The identification of missing messages is based on the simple numbering of each message which is sent from the team control of one telecommunications system to another telecommunications system. On receiving a message from a partner system, the team control in each individual telecommunications system buffer-stores the number of the most recently received message in a list (one entry for each partner system). When the next message from that partner system is now received, the buffer-stored number is compared with the number of the new message. If the number of the new message is greater by 1, than that of the buffer-stored message, then no messages have been lost, and the call signaling can be processed as normal. If the delta between the buffer-stored number and the number of the new message is not equal to 1, then a fault has occurred. All new messages from the corresponding partner system are now rejected until all the signaling activities relating to the system have been reset.

Thus, in the described system, potentially faulty signaling activities of switching statuses are rejected by team partners in the partner system.

If all the cross-relationships have now been reset once again, then the signaling restarts; that is to say, on receiving the next message from the partner system, the number of the message is once again transferred to the global list for team administration, and the signaling in the team is processed. If the team control in a telecommunications system receives a message with the number 0 from a partner system, then this is an indication that this system is starting up from new (“initial contact”). If there is still any call signaling outstanding for this partner system, then, if necessary, this is also reset (see above).

In addition to the fault identification methods that have already been described, the described team solution uses the method described in the following text in order to identify whether a partner system is still accessible. The team control in a telecommunications system has, in its global data, information as to which partner systems it has “active relationships” with. The information is thus maintained in that a switching state not equivalent to free is signaled for at least one “imaginary team subscriber” in the partner system “X”.

On receiving a message from a partner system, a time stamp is also stored in a global list (one entry for each partner system), analogously to the number of the message. This list is now processed cyclically (for example, once a minute) for all the partner systems with which active relationships exist; that is to say, the current system time is compared with the stored time stamp for receipt of the last message.

If a predetermined limit value has now been exceeded (for example, two minutes), then a message reporting is sent to the corresponding partner system. If the partner system answers this request correctly, then this mechanism starts once again after a predetermined time, if no “normal” message has arrived from the partner system in the meantime. If the partner system does not respond before the next cyclic comparison of the times, then it is regarded as being no longer accessible, and all the call statuses are reset, as already described.

This mechanism ensures that all calls to a partner system are rejected after a finite time following the failure of the connection; that is, a team call does not ring out endlessly.

The advantage of the described mechanism is that the partner systems are polled only when active relationships with this partner system exist and no more messages have been signaled from this system for a lengthy period of time. This minimizes the message traffic between the telecommunications systems.

Owing to the long polling times for the “live control” mechanism described above, it is possible for the connection to a partner system to be interrupted, but for this not yet to have been identified. That is to say, a team call for a team subscriber in the partner system is still signaled even though it is no longer accessible. If an attempt is now made to accept this team call, then this results in a negative acknowledgement from the switching. This negative acknowledgement is used as an indicator that the team partner is no longer accessible, and the relevant team call is automatically reset. Furthermore, the mechanism described above is started prematurely for the relevant partner system, with the “Hello, are you still alive?” message thus being sent to that partner system and, if it does not respond within a defined time, all cross-relationships relating to the switching statuses for that partner system are reset.

Although the present invention has been described with reference to specific embodiments, those of skill in the art will recognize the changes may be made thereto without departing from the spirit and scope of the invention as set forth and the hereafter appended claims.

1. A method for operating a team configuration, formed of a plurality of subscribers, in a system formed of a plurality of mutually connected telecommunications devices, the method comprising the steps of:
providing process instances for each subscriber in each of the telecommunications devices for normal telecommunications operation;
setting up at least one of a real and an imaginary instance for each subscriber in each of the telecommunications devices; and
enabling the telecommunications devices to communicate with one another with equal priority.

2. A method for operating a team configuration as claimed in claim 1, wherein, for a team configuration with n telecommunications devices, each subscriber is assigned one real instance and n-1 imaginary instances.

3. A method for operating a team configuration as claimed in claim 1, the method further comprising the step of:
signaling each status change of a subscriber only once to a partner telecommunications device, wherein team functionality is controlled via the imaginary instance assigned to the subscriber at the partner telecommunications device.

4. A method for operating a team configuration as claimed in claim 1, the method further comprising the steps of:
identifying at least one of a failure of one of the telecommunications devices and a failure of a routing path to one of the telecommunications devices;
ending, automatically, an existing team call upon identification of the failure; and
resetting all the call statuses.

5. A method for operating a team configuration as claimed in claim 4, wherein switching statuses of the subscribers are not refreshed in response to reactivation of the failed telecommunications device.

6. A method for operating a team configuration as claimed in claim 1, the method further comprising the step of:
configuring the team configuration via a program which is independent of any operation control and which is implemented in one of a data processing device externally connected to the system and one of the telecommunications devices.

7. A method for operating a team configuration as claimed in claim 1, the method further comprising the step of implementing team performance features over the entire system wherein the team performance features include signaling of team calls, signaling of busy states via an optical display at an appropriate terminal, a capability to receive a team call, a capability to directly call a subscriber in the team via a function key, a capability to allocate a call to a subscriber in the team via a function key, a capability to activate/deactivate distribution of one's own calls in the team, and a capability to activate/deactivate signaling of other team calls at one's own terminal.

8. A method for operating a team configuration as claimed in claim 7, wherein the signaling of a team call is freely programmable via the function key on a respective telecommunications terminal.

9. A method for operating a team configuration as claimed in claim 7, wherein team calls are signaled acoustically via one of a normal call and a short call.

10. A method for operating a team configuration as claimed in claim 7, wherein team calls are signaled visually on one of a display and the function key of the respective telecommunications terminal.

11. A method for operating a team configuration as claimed in claim 7, wherein the team performance feature of receiving a team call, activating/deactivating the signaling for other team calls on the telecommunications terminal of a subscriber, and activating/deactivating the distribution of one's own calls in the team are each carried out via a specific function key on the telecommunications terminal.

12. A method for operating a team configuration as claimed in claim 7, wherein the team performance features of receiving a team call, activating/deactivating the signaling of other team calls on the telecommunications terminal of a subscriber, and activating/deactivating the distribution of one's own calls in the team are each carried out via a menu item in a visual menu control system.

13. A method for operating a team configuration as claimed in claim 1, the method further comprising the step of incorporating purely virtual subscribers having their own telephone numbers but no real instances.

14. A system for operating a team configuration formed of a plurality of subscribers, the system formed of a plurality of mutually connected telecommunications devices, each telecommunications devices comprising:
a team controller associated with a control of system telecommunications terminals;
first and second internal interfaces associated directly with the control of the system telecommunications terminals, and
first and second external interfaces, addressed indirectly by the control of the system telecommunications terminals, as configuration and signaling connections for team-internal signaling.

15. A system for operating a team configuration as claimed in claim 14, wherein the first and second internal interfaces connect the control for the system telecommunications terminals, and the team control, to one of a central operating technology component and a central switching component.

16. A system for operating a team configuration as claimed in claim 15, wherein the first external interface connects the central operation technology component to one of a corresponding component in another telecommunications device and a configuration tool, and the second external interface connects the central switching components of two telecommunications devices to one another.
